(19) United States
(12) Patent Application Publication
(10) Pub. No.: US 2012/0054014 A1
(43) Pub. Date: Mar. 1, 2012

(54) APPARATUS AND METHOD FOR PROVIDING COUPON SERVICE IN MOBILE COMMUNICATION SYSTEM

(75) Inventors: Ik-Hwan Cho, Suwon-si (KR); Kwang-Cheol Choi, Gwacheon-si (KR); Dae-Kyu Shin, Suwon-si (KR); Seung-Pyo Ryu, Suwon-si (KR); Shin-Jun Lee, Yongin-si (KR); Sung-Joo Ahn, Seoul (KR); Jin-He Jung, Suwon-si (KR); Tae-Hwan Son, Suwon-si (KR)

(73) Assignee: SAMSUNG ELECTRONICS CO., LTD., Suwon-si (KR)

(21) Appl. No.: 13/198,474

(22) Filed: Aug. 4, 2011

(30) Foreign Application Priority Data
Aug. 25, 2010 (KR) 10-2010-0082284

(51) Int. Cl. G06Q 30/00

(52) U.S. Cl. 705/14.26; 705/14.39

(57) ABSTRACT

An apparatus and method for providing a coupon service in a mobile communication system are provided. A method of operating a user terminal for providing a coupon service in a mobile communication system includes receiving coupon information of one or more shops that exist within a specified range around the user terminal from a Social Network Service (SNS) server, displaying the received coupon information, and generating a coupon by using the coupon information of the shop at the request of the coupon information, wherein the SNS server receives coupon information uploaded from a vendor terminal and Global Positioning System (GPS) information of a shop capable of using the coupon service.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Aug. 25, 2010 and assigned Serial No. 10-2010-0082284, the entire disclosure of which is hereby incorporated by reference.

### FIELD OF THE INVENTION

The present disclosure relates to an apparatus and method for providing a coupon service in a mobile communication system. More particularly, the present disclosure relates to an apparatus and method for providing a coupon service by utilizing an Augmented Reality (AR) technique based on a Social Network Service (SNS) and a Location Based Service (LBS) in a mobile communication system.

### BACKGROUND OF THE INVENTION

To promote sales of products or services, a coupon may be used as a marketing tool. Information is typically written on a sheet of paper in a manner such that the information may be verified to prove that the coupon may be approved by a seller or a coupon issuer. When a customer provides the coupon to a vender; in response, the vendor may provide a service or a discount to the customer. A coupon book typically includes a collection of such paper coupons. Respective coupons issued by one or more vendors are collected in the coupon book, such that the customer can select one or more coupons from the collected set.

Because many businesses or vendors now consider the Internet as a useful marketing tool, they have begun displaying banner advertisements in their web sites or portal sites. Event information may be reported to induce a customer to download a coupon, thereby maximizing an advertising effect. In addition, with the increase of cell phone users, a coupon service using a Multimedia Messaging Service (MMS) has been implemented. Using this coupon service, a vendor transmits, to a user, a specific message such as a coupon image or a bar code by using the MMS, and the user receives a service after showing the message in a shop.

Such a web- or mobile-based event or coupon service has now become a general marketing tool in many fields. However, many damages and complaints are being reported from users. Basically, the user has to search for coupons one by one through a web browser in which unsolicited coupon information may cause inconvenience to the user. From the perspective of a vendor, it is not easy to correctly identify regular customers who contribute to the sales of the vendor, which often results in excessive issuing of coupons to many unspecified individuals. Therefore, these drawbacks may create an undue burden for regular customers who frequently buy products of the vendor. Further, it is difficult to recognize a regular customer who frequently uses the product of the vendor among many customers to whom the coupon is issued. In addition, there is a disadvantage in that no passive manner of issuing the coupon is not generally available to users.

An Augmented Reality (AR) technique has been developed for use in marketing or advertisement. The AR technique generally refers to one particular field of a virtual reality technology. In the AR technique, virtual objects are combined such that they may be viewed as if they exist in an original environment. Due to its technical novelty as well as its convenience of use and entertainment aspects, application of the AR technique is growing on a daily basis. However, this coupon service is mainly intended to draw the attention of customers, and is mostly considered as a pseudo AR which uses only Global Positioning System (GPS) and compass information, which is not sufficient to be called as real AR. Nevertheless, the coupon service has attracted attentions in a sense that it may enhance the interests of users. Thus, a mobile coupon service using the conventional AR technique may have several drawbacks.

The conventional mobile coupon service uses a vendor that provides a coupon service in addition to a business that intends to provide a service and perform marketing. That is, the individual vendor registers its coupon service contents to a coupon service business, and the coupon business provides the contents to individual users. In this process, the individual vendor often has to pay a certain commission to the coupon vendor in order to provide the coupon service. Further, since the coupon vendor provides customers with a coupon in practice, it may be difficult for the service business to directly access to the customer.

The conventional mobile coupon sever using conventional AR techniques may also exhibit problems. Similarly to many AR applications which have been implemented, the coupon service based on the AR technique currently uses only GPS-assisted position information to simply render a corresponding object on a camera screen. Therefore, target shop information may be difficult to provide, and thus there is a likelihood that the user randomly may download unnecessary coupons. In addition, there is a disadvantage in that the service may not be used in an indoor environment where GPS information is not received.

### SUMMARY OF THE DISCLOSURE

To address the above-discussed deficiencies of the prior art, it is a primary object to provide at least the advantages described below. Accordingly, an aspect of the present disclosure is to provide an apparatus and method for providing a coupon service in a mobile communication system.

Another aspect of the present disclosure is to provide an apparatus and method for providing a coupon service by utilizing an Augmented Reality (AR) technique based on a Social Network Service (SNS) and a Location Based Service (LBS) in a mobile communication system.

Another aspect of the present disclosure is to provide an apparatus and method in which a vendor that intends to provide a coupon service provides a discriminated coupon or event directly to a customer at no cost on a real-time basis by using an SNS, such that a customer may receive real-time information in a simple and convenient manner.

Another aspect of the present disclosure is to provide an apparatus and method in which a customer can receive a coupon for a specific shop in an intuitive and entertaining manner.

In accordance with an aspect of the present disclosure, a method of operating a user terminal for providing a coupon service in a mobile communication system is provided. The method includes receiving coupon information of one or more shops that exist within a specified range around the user terminal from an SNS server, displaying the received coupon information, and generating a coupon by using the coupon information of the shop at the request of the coupon information, wherein the SNS server receives coupon information uploaded from a vendor terminal and Global Positioning System (GPS) information of a shop capable of using the coupon service.

In accordance with another aspect of the present disclosure, a method for providing a coupon service in a mobile communication system is provided. The method includes uploading, by a vendor terminal, coupon information and GPS information of a shop capable of using the coupon service to a SNS server, transmitting, by the SNS server, coupon information of one or more shops that exist within a specified range of a user terminal to the user terminal, displaying, by the user terminal, the coupon information received from the SNS server, and generating, by the user terminal, a coupon by using the coupon information of the shop at the request of the coupon information.

In accordance with another aspect of the present disclosure, a user terminal is provided. The user terminal includes a communication unit for receiving coupon information of one or more shops that exist within a specified range around the user terminal from an SNS server, a display unit for displaying the received coupon information, and a coupon issuing SoftWare (S/W) entity for generating a coupon by using the coupon information of the shop at the request of the coupon information, wherein the SNS server receives coupon information uploaded from a vendor terminal and GPS information of a shop capable of using the coupon service.

In accordance with another aspect of the present disclosure, a mobile communication system for providing a coupon service is provided. The mobile communication system includes a vendor terminal for uploading coupon information and GPS information of a shop capable of using the coupon service to an SNS server, the SNS server for transmitting coupon information of one or more shops that exist within a specified range of a user terminal to the user terminal, and the user terminal for displaying the coupon information received from the SNS server and for generating a coupon by using the coupon information of the shop at the request of the coupon information.

Before undertaking the DETAILED DESCRIPTION OF THE DISCLOSURE below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example mobile communication system according to this disclosure;

FIG. 2 illustrates an example a user terminal according to this disclosure;

FIG. 3 illustrates an example method of operating a vendor terminal for providing a coupon service according to this disclosure;

FIG. 4 illustrates and example method of operating an image sharing service server for providing a coupon service according to this disclosure;

FIG. 5 illustrates an example method of operating a Social Network Service (SNS) server for providing a coupon service according to this disclosure; and

FIGS. 6A and 6B illustrate an example method of operating a user terminal for providing a coupon service according to this disclosure.

### DETAILED DESCRIPTION OF THE INVENTION

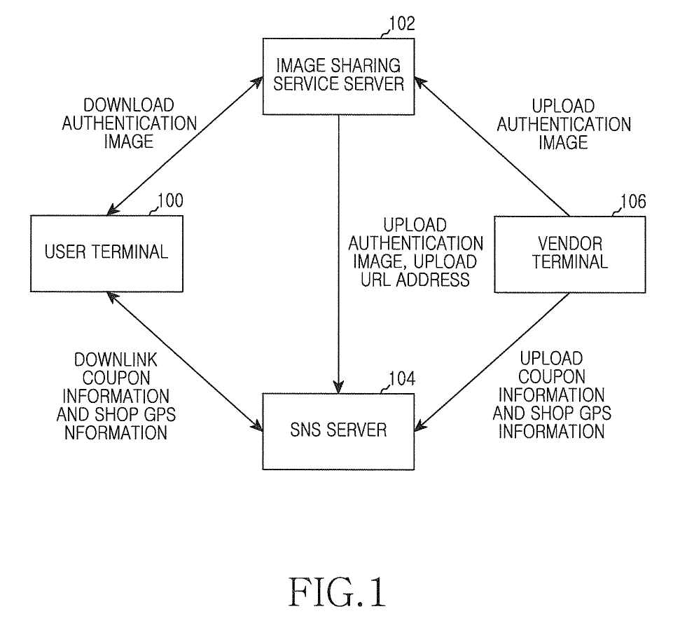

FIGS. 1 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication system. In the following description, well-known functions or constructions are not described in detail since they would obscure the disclosure in unnecessary detail. Also, the terms used herein are defined according to the functions of the present disclosure. Thus, the terms may vary depending on user's or operator's intension and usage. That is, the terms used herein must be understood based on the descriptions made herein.

The present disclosure described hereinafter relates to a method for providing a coupon service in a mobile communication system. More particularly, the present disclosure relates to an apparatus and method for providing a coupon service by utilizing an Augmented Reality (AR) technique based on a Social Network Service (SNS) and a Location Based Service (LBS) in a mobile communication system.

FIG. 1 is a block diagram illustrating a mobile communication system according to this disclosure. The mobile communication system disclosure includes a user terminal 100, an image sharing service server 102, an SNS server 104, and a vendor terminal 106.

The user terminal 100 is configured to receive a coupon. The user terminal 100 receives user input for a couple issuing SoftWare (S/W) program for issuing the coupon, and provides a coupon service by utilizing an AR technique based on an SNS or an LBS. In particular, the user terminal 100 transmits Global Positioning System (GPS) information of the user terminal 100 to a map server and the SNS server 104 to obtain neighboring map information of the user terminal and also GPS information and coupon information of one or more shops that exist nearby. Then, the user terminal 100 combines the obtained information and displays it on a screen. Further, at the request of the coupon information for one of the shops, the user terminal 100 requests an authentication image Uniform Resource Locator (URL) address for that shop and obtains the address. Then, the user terminal 100 transmits the obtained authentication image URL address to the image sharing service server 102 to obtain a corresponding authentication image. Furthermore, the user terminal 100 receives user input for requesting a camera to capture an image, and performs authentication by comparing the captured image and the obtained authentication image in terms of a similarity. If the authentication is successful, the user terminal 100 generates a virtual three-Dimensional (3D) coupon by using the coupon information, and issues a corresponding coupon by displaying the generated virtual 3D coupon together with an image being captured by the camera.

The image sharing service server 102 stores an authentication image in a memory. Herein, the authentication image is uploaded from the vendor terminal 106 by using an image sharing service account of a vendor. Then, the image sharing service server 102 uploads a URL address of the authentication image stored in the memory to the SNS server 104. Further, the image sharing service server 102 transmits the authentication image to the user terminal upon receiving the URL address of the authentication image from the user terminal 100.

The SNS server 104 is configured to provide image and text uploading, and may include a subscriber-based service server for providing geo-location information through an Open Application Program Interface (API). When the vendor or a general user that is subscribed to an SNS creates an account, then a right to freely update a text is given to the vendor or the user having the account. In addition to its typical function, according to the present disclosure, the SNS server 104 maps coupon information uploaded from the vendor terminal 106 by using an SNS account of the vendor, GPS information of a shop capable of using the coupon service, and an authentication image URL address uploaded from the image sharing service server 102, and stores them into the memory. Further, the SNS server 104 transmits the coupon information and the GPS information of shops located near the user terminal upon receiving the GPS information from the user terminal 100, and transmits the authentication image URL address mapped to the shops to the user terminal 100 at the request of the authentication image URL address for one of the shops.

As a terminal that intends to issue a coupon, the vendor terminal 106 receives input for a coupon registering S/W program for coupon registration to upload coupon information and GPS information of a shop capable of using a corresponding coupon service. Further, the vendor terminal 106 uploads an authentication image to be used for authentication when issuing the coupon to the user.

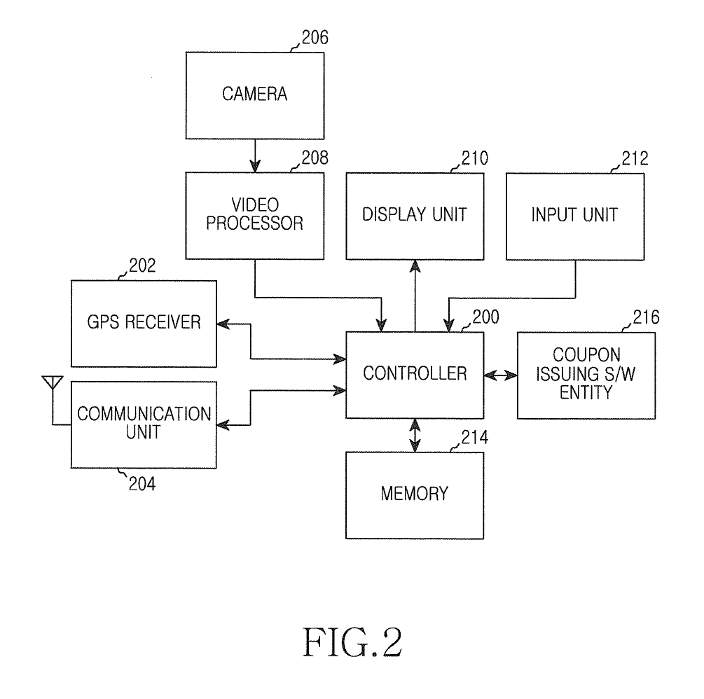

FIG. 2 illustrates an example user terminal according to this disclosure. The user terminal includes a controller 200, a GPS receiver 202, a communication unit 204, a camera 206, a video processor 208, a display unit 210, an input unit 212, a memory 214, and a coupon issuing S/W entity 216.

The controller 200 may provide overall control of the user terminal. For example, the controller 200 processes and controls voice calls and data communications. In addition to its typical functions, the controller 200 may process a function for providing the coupon service by utilizing an AR technique based on an SNS and an LBS.

The GPS receiver 202 receives GPS information from a GPS satellite, and provides the received GPS coupon to the coupon issuing S/W entity 216.

The communication unit 204 includes a Radio Frequency (RF) transmitter for up-converting and amplifying a frequency of a transmitted signal and an RF receiver for performing low-noise amplification on a received signal and for down-converting a frequency thereof.

The camera 206 includes a camera sensor for converting an optical signal detected in image capturing into an electrical signal and a signal processor for converting an analog image signal captured from the camera sensor into digital image data. Herein, the camera sensor can be implemented by using a Charge Coupled Device (CCD) sensor, and the signal processor can be implemented by using a Digital Signal Processor (DSP).

The image processer 208 generates screen data for displaying the camera image data provided from the camera 206. The image processer 208 includes a video codec (not shown). The video codec codes the image data according to a specified scheme, or decodes the coded image data into original image data.

The display unit 210 displays information such as state information, which is generated while the user terminal operates, a limited number of characters, a large volume of moving and still pictures, and the like. The display unit 210 may be a color Liquid Crystal Display (LCD).

The input unit 212 includes a plurality of function keys such as numeral key buttons, a menu button, a cancel/delete button, an OK button, a talk button, an end button, a camera button, an Internet access button, etc. Key input data, which is input when the user presses these keys, is provided to the controller 200.

The memory 214 stores instructions of a program for processing and control of the controller 200 and a variety of reference data. In particular, the memory 214 stores a program for providing a coupon service by utilizing the AR technique based on the SNS and the LBS. In addition, the memory 214 stores a coupon generated by the coupon issuing SAY entity 216.

The coupon issuing S/W entity 216 transmits GPS information to a map server and an SNS server via the communication unit 204 to obtain neighboring map information of the user terminal and coupon information and GPS information of one or more shops that exist nearby, and displays the obtained information to a screen by means of the display unit 210. Further, at the request of coupon information for one of the shops, the coupon issuing S/W entity 216 obtains an authentication image URL address for one shop by requesting the SNS server to send the URL address and also obtains a corresponding authentication image by transmitting the obtained authentication image URL address to an image sharing service server. Further, the coupon issuing S/W entity 216 captures an image by using the camera 206, and performs authentication by comparing the captured image with the obtained authentication image, and if authentication is successful, generates a virtual 3D coupon by using the coupon information, and issues a corresponding coupon by displaying it on the display unit 210 together with an image screen being captured by the camera 206.

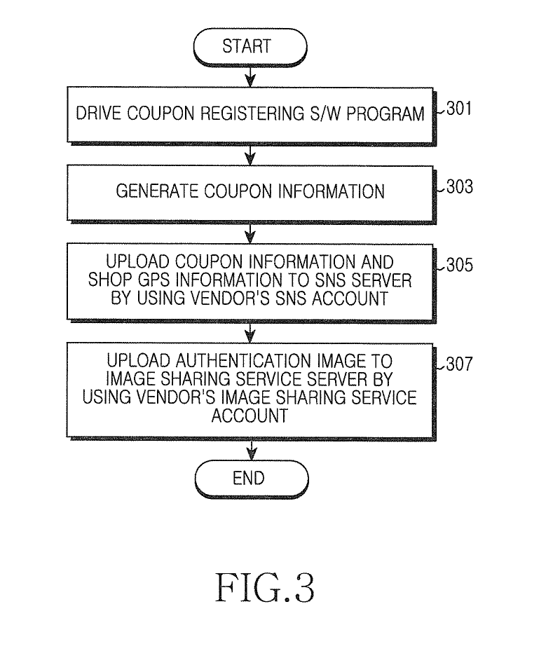

FIG. 3 illustrates an example method of operating a vendor terminal for providing a coupon service according to this disclosure.

First, the vendor terminal receives input for a coupon registering S/W program for registering a coupon in step 301.

In step 303, the vendor terminal generates coupon information to be registered. Herein, the generated coupon information includes a dedicated hash tag predefined to indicate that the information includes coupon information.

In step 305, the vendor terminal uploads the generated coupon information and GPS information of a shop capable of using the coupon service to an SNS server by using a vendor's SNS account.

In step 307, the vendor terminal uploads an authentication image, which is to be used for authentication when issuing the coupon to the user, to an image sharing service server by using a vendor's image sharing service account.

Thereafter, the method of FIG. 3 ends.

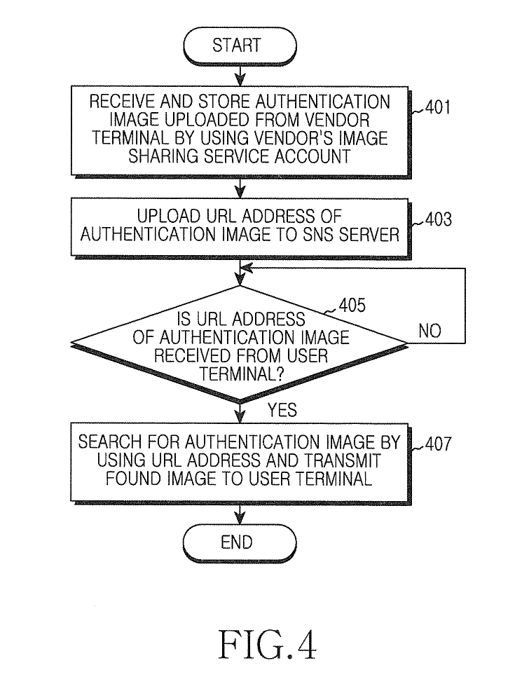

FIG. 4 illustrates an example method of operating an image sharing service server for providing a coupon service according to this disclosure.

First, the image sharing service server receives an authentication image to be used for issuing a coupon to a user and stores the received authentication image into a memory in step 401. Herein, the authentication image may be uploaded from a vendor terminal by using a vendor's image sharing service account

In step 403, the image sharing service server uploads a URL address of the stored authentication image to an SNS server. The URL address indicates a position at which the authentication image is stored. The image sharing service server can search for the authentication image from the memory by using the URL address.

In step 405, the image sharing service server determines whether the URL address of the stored authentication image is received from a user terminal. If it is determined in step 405 that the URL address of the stored authentication image is received from the user terminal, proceeding to step 407, the image sharing service server searches for the authentication image from the memory by using the received URL address, and transmits the found authentication image to the user terminal.

Thereafter, the method of FIG. 4 ends.

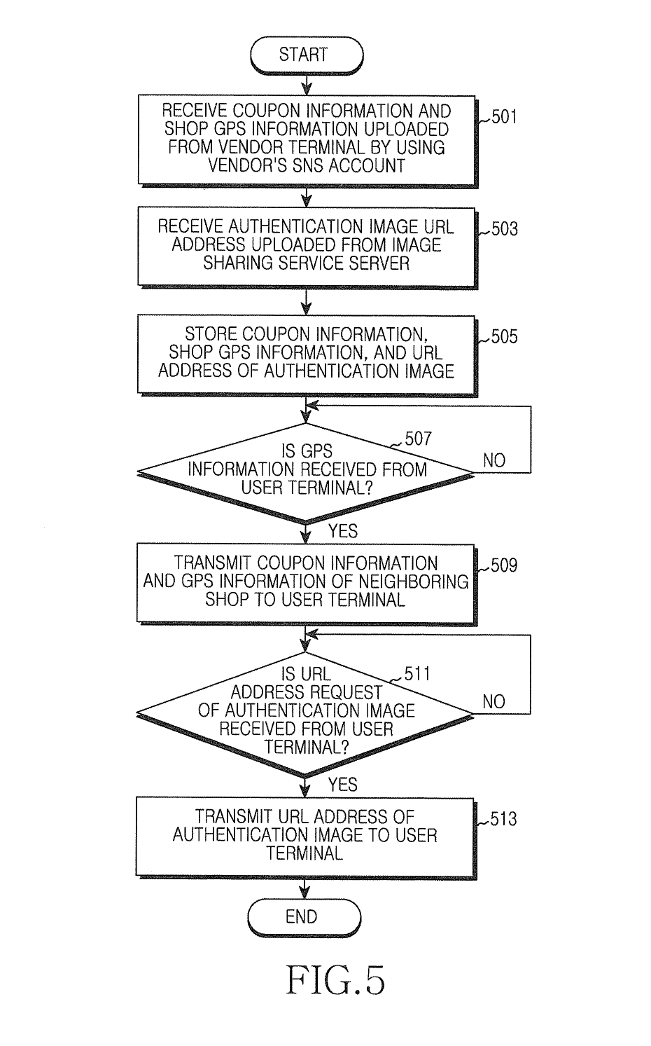

FIG. 5 illustrates an example method of operating an SNS server for providing a coupon service according to this disclosure.

First, the SNS server receives coupon information uploaded from a vendor terminal and GPS information of a shop capable of using the coupon service by using a vendor's SNS account in step 501. The coupon information includes a dedicated hash tag predefined to indicate that the information is coupon information.

In step 503, the SNS server receives a URL address of an authentication image to be used for authentication when issuing a coupon to the user. The URL address is uploaded from an image sharing service server.

In step 505, the SNS server maps the coupon information and shop GPS information received from the vendor terminal and the authentication image's URL address received from the image sharing service server and stores them into a memory.

In step 507, the SNS server determines whether the GPS information of the user terminal is received from a user terminal

If it is determined in step 507 that the GPS information of the user terminal is received from the user terminal, proceeding to step 509, the SNS server searches for one or more shops that exist within a specified range around the user terminal by using the GPS information of the user terminal and the per-shop GPS information stored in the memory. Further, the SNS server filters coupon information of the found one or more shops and transmits the filtered coupon information to the user terminal together with the GPS information of the shop. The SNS server can use a dedicated hash tag included in the coupon information to perform filtering by identifying the coupon information from other information.

In step 511, the SNS server determines whether a request for the URL address of the authentication image mapped to one shop among the found one or more shops is received from the user terminal. If it is determined in step 511 that the request for the URL address of the authentication image mapped to one shop among the found one or more shops is received from the user terminal, proceeding to step 513, the SNS server transmits the URL address of the authentication image mapped to the shop to the user terminal.

Thereafter, the method of FIG. 5 ends.

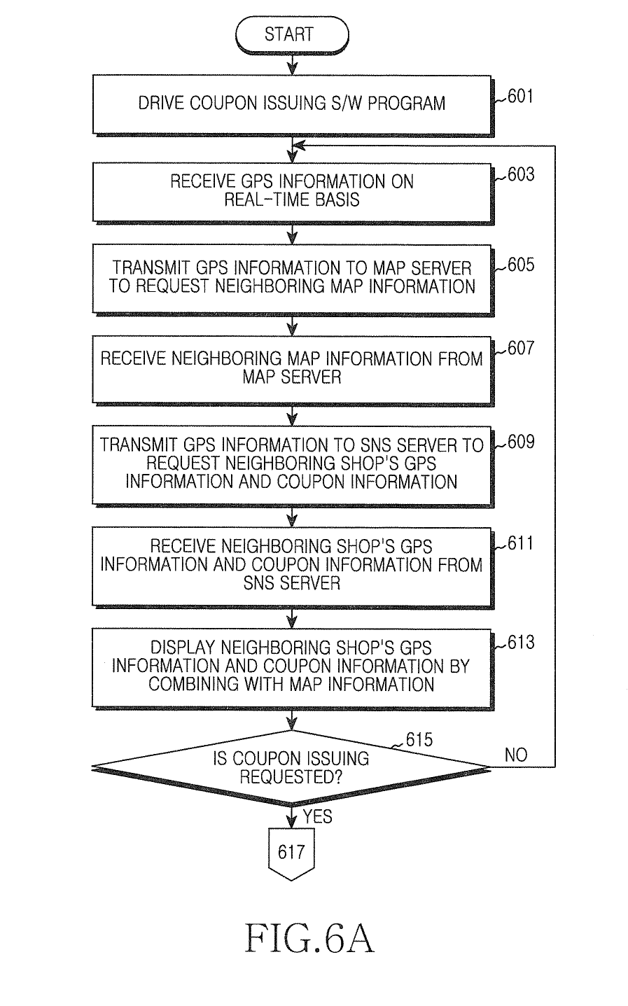

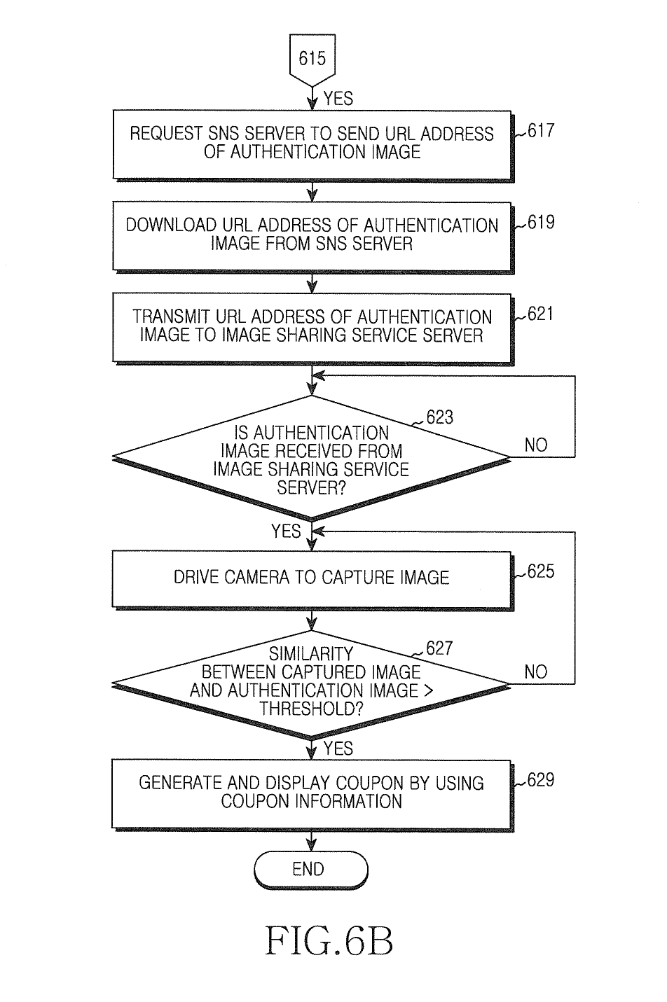

FIGS. 6A and 6B illustrate an example method of operating a user terminal for providing a coupon service according to this disclosure.

First, the user terminal receives user input for a coupon issuing S/W program for issuing a coupon in step 601, and receives GPS information from a GPS satellite via a GPS receiver on a real-time basis in step 603.

In step 605, the user terminal transmits to a map server, the GPS information received on a real-time basis to request map information within a specified range around the user terminal. In step 607, the user terminal receives the map information of a neighboring environment from the map server.

In step 609, the user terminal transmits to an SNS server the GPS information received on a real-time basis to request coupon information and GPS information of a shop that exists within the specified range around the user terminal. In step 611, the user terminal receives coupon information and GPS information of one or more neighboring shops from the SNS server.

In step 613, the user terminal displays the coupon information and GPS information regarding the one or more neighboring shops by combining the information with the map information.

In step 615, the user terminal determines a coupon issuing request for one shop among the one or more neighboring shops displayed according to user's key manipulation. If it is determined in step 615 that the coupon issuing request for one shop is not detected from the one or more neighboring shops during a specified time period, returning to step 603, the subsequent steps are repeated.

Otherwise, if it is determined in step 615 that the coupon issuing request for one shop is detected among the one or more neighboring shops, proceeding to step 617, the user terminal requests the SNS server to send a URL address of an authentication image mapped to the one shop. In step 619, the user terminal downloads the URL address of the authentication image mapped to the one shop from the SNS server.

In step 621, the user terminal transmits the downloaded authentication image URL address to an image sharing service server. In step 623, the user terminal determines whether an authentication image corresponding to the authentication image URL service is received from the image sharing service server.

If it is determined in step 623 that the authentication image corresponding to the authentication image URL address is received from the image sharing service server, proceeding to step 625, the user terminal receives requests for a camera to capture an image according to user's key manipulation. In step 627, the user terminal determines whether a similarity between the captured image and the received authentication image is greater than a threshold. If it is determined in step 627 that the similarity between the captured image and the received authentication image is not greater than the threshold, returning to step 625, the subsequent steps are repeated.

Otherwise, if it is determined in step 627 that the similarity between the captured image and the received authentication image is greater than the threshold, proceeding to step 629, the user terminal generates a coupon by using the received coupon information, and displays the generated coupon to a display unit. For example, if the received coupon information includes information indicating ‘10% discount’, the user terminal may generate a virtual 3D coupon on which the ‘10% discount’ is written, and then display the generated virtual 3D coupon to the display unit together with an image screen being captured by a camera. In this case, a user selects the virtual coupon on the image screen to store the coupon. By showing the stored virtual coupon in a shop, the user can receive a service corresponding to the virtual coupon from the shop. For this, the user terminal determines whether a selection of the display coupon is detected, and upon detection of the selection, stores the coupon in a memory.

Thereafter, the method of FIGS. 6A and 6B ends.

According to exemplary embodiments of the present disclosure, an Augmented Reality (AR) technique based on a Social Network Service (SNS) and a Location Based Service (LBS) is utilized in a mobile communication system, so that a vendor that intends to provide a coupon service provides a discriminated coupon or event directly to a customer on a real-time basis at no cost by using the SNS, and the customer can conveniently and easily receive the real-time information. In addition, there is an advantage in that the customer can receive a coupon for a specific shop in an intuitive and entertaining manner. For example, a virtual coupon can be issued when a specific image determined by a shop owner is captured by a camera, so that users can access to the service in an entertaining manner, and the vendor may enhance an advertisement effect.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of operating a user terminal for providing a coupon service in a mobile communication system, the method comprising:
receiving coupon information of one or more shops that exist within a predetermined range around the user terminal from a Social Network Service (SNS) server;
displaying the received coupon information; and
generating a coupon by using the coupon information of the shop at a request of the coupon information;
wherein the SNS server receives coupon information uploaded from a vendor terminal and Global Positioning System (GPS) information of a shop providing the coupon service.

2. The method of claim 1, further comprising:
receiving GPS information of the user terminal;
transmitting the received GPS information of the user terminal to a map server; and
receiving map information within the specified range around the user terminal from the map server;
wherein the received coupon information is displayed by combining with the received map information.

3. The method of claim 2, further comprising requesting the coupon information by transmitting the received GPS information of the user terminal to the SNS server, wherein the coupon information is received together with the GPS information for the shop.

4. The method of claim 1, further comprising:
before the generating of the coupon, requesting the SNS server to send a Uniform Resource Locator (URL) address of an authentication image mapped to the shop at the request of the coupon information;
receiving the URL address of the authentication image from the SNS server;
transmitting the received authentication image URL address to an image sharing service server;
receiving the authentication image from the image sharing service server; and
performing authentication by using the received authentication image;
wherein the image sharing service server receives and stores the authentication image uploaded from the vendor terminal, and uploads the URL address of the stored authentication image to the SNS server.

5. The method of claim 4, wherein the performing of the authentication comprises:
capturing an image by issuing requests to a camera; and
determining whether a similarity between the captured image and the received authentication image is greater than a threshold.

6. The method of claim 5, further comprising displaying the image captured by the camera together with the generated coupon, wherein the generated coupon comprises a virtual 3 Dimensional (3D) coupon.

7. The method of claim 6, wherein storing the coupon in a memory upon detection of a selection of the displayed coupon.

8. A method for providing a coupon service in a mobile communication system, the method comprising:
uploading, by a vendor terminal, coupon information and Global Positioning System (GPS) information of a shop capable of using the coupon service to a Social Network Service (SNS) server;
transmitting, by the SNS server, coupon information of one or more shops that exist within a predetermined range of a user terminal to the user terminal;
displaying, by the user terminal, the coupon information received from the SNS server; and
generating, by the user terminal, a coupon by using the coupon information of the shop at the request of the coupon information.

9. The method of claim 8, further comprising:
receiving, by the user terminal, GPS information of the user terminal;
transmitting, by the user terminal, the received GPS information of the user terminal to a map server; and
receiving, by the user terminal, map information within the specified range around the user terminal from the map server;
wherein the received coupon information is displayed by combining with the received map information.

10. The method of claim 9, further comprising requesting, by the user terminal, the SNS server to send the coupon information by transmitting the received GPS information of the user terminal, wherein the coupon information is received together with GPS information of the shop.

11. The method of claim 8, further comprising:
uploading, by the vendor terminal, an authentication image mapped to the shop to an image sharing service server; and
receiving and storing, by the image sharing service server, the authentication image and uploading a Uniform Resource Locator (URL) address of the stored authentication image to the SNS server.

12. The method of claim 11, wherein before the generating of the coupon, further comprising:
requesting, by the user terminal, the SNS server to send the URL address of the authentication image mapped to the shop at the request of the coupon information;
transmitting, by the SNS server, the URL address of the authentication image to the user terminal;
transmitting, by the user terminal, the received authentication image URL address to the image sharing service server;
transmitting, by the image sharing service server, the authentication image to the user terminal; and
performing, by the user terminal, authentication by using the authentication image.

13. The method of claim 12, wherein the performing of the authentication comprises:
capturing, by the user terminal, an image by issuing requests to a camera; and
determining, by the user terminal, whether a similarity between the captured image and the received authentication image is greater than a threshold.

14. The method of claim 13, further comprising displaying, by the user terminal, the image captured by the camera together with the generated coupon, wherein the generated coupon comprises a virtual 3 Dimensional (3D) coupon.

15. The method of claim 14, further comprising storing, by the user terminal, the coupon into a memory upon selection of the displayed coupon.

16. A user terminal comprising:
a communication unit for receiving coupon information of one or more shops that exist within a predetermined range around the user terminal from a Social Network Service (SNS) server;
a display unit for displaying the received coupon information; and
a coupon issuing SoftWare (S/W) entity for generating a coupon by using the coupon information of the shop at the request of the coupon information,
wherein the SNS server receives coupon information uploaded from a vendor terminal and Global Positioning System (GPS) information of a shop providing the coupon service.

17. The user terminal of claim 16, further comprising:
a GPS receiver for receiving GPS information of the user terminal;
wherein the communication unit is configured to transmit the received GPS information of the user terminal to a map server, and receive map information within the specified range around the user terminal from the map server, and wherein the display unit is configured to display the received coupon information by combining with the received map information.

18. The user terminal of claim 17, wherein the communication unit is configured to request the coupon information by transmitting the received GPS information of the user terminal to the SNS server, and receive the coupon information together with the GPS information for the shop.

19. The user terminal of claim 16, wherein the communication unit is configured to request the SNS server to send a Uniform Resource Locator (URL) address of an authentication image mapped to the shop at the request of the coupon information, receives the URL address of the authentication image from the SNS server, transmit the received authentication image URL address to an image sharing service server, and receive the authentication image from the image sharing service server;
wherein the coupon issuing S/W entity is configured to perform authentication by using the received authentication image, and
wherein the image sharing service server is configured to receive and store the authentication image uploaded from the vendor terminal, and upload the URL address of the stored authentication image to the SNS server.

20. The user terminal of claim 19, wherein the coupon issuing S/W entity is configured to determine whether a similarity between an image captured by issuing requests to a camera and whether the received authentication image is greater than a threshold.

21. The user terminal of claim 20,
wherein the display unit is configured to display the image captured by the camera together with the generated coupon, and
wherein the generated coupon comprises a virtual three-Dimensional (3D) coupon.

22. The user terminal of claim 21, further comprising a memory for storing the coupon upon detection of a selection of the displayed coupon.

23. A mobile communication system for providing a coupon service, comprising:
a vendor terminal for uploading coupon information and Global Positioning System (GPS) information of a shop capable of using the coupon service to a Social Network Service (SNS) server;
the SNS server for transmitting coupon information of one or more shops that exist within a predetermined range of a user terminal to the user terminal, the user terminal for displaying the coupon information received from the SNS server and for generating a coupon by using the coupon information of the shop at the request of the coupon information.

24. The mobile communication system of claim 23, wherein the user terminal is configured to receive GPS information of the user terminal, transmit the received GPS information of the user terminal to a map server, and receive map information within a specified range around the user terminal from the map server, and
wherein the received coupon information is configured to be displayed by combining with the received map information.

25. The mobile communication system of claim 24, wherein the user terminal is configured to request the SNS server to send the coupon information by transmitting the received GPS information of the user terminal, and
wherein the coupon information is received together with GPS information of the shop.

26. The mobile communication system of claim 23, further comprising an image sharing service server for receiving and storing an authentication image uploaded from the user terminal, and for uploading a Uniform Resource Locator (URL) address of the stored authentication image to the SNS server, wherein the vendor terminal is configured to upload the authentication image mapped to the shop to the image sharing service server.

27. The mobile communication system of claim 26, Wherein, at the request of the coupon information, the user terminal being configured to request that the SNS server send the URL address of the authentication image mapped to the shop to receive the URL address, transmit the received authentication image URL address to the image sharing service server to receive the authentication image, and perform authentication by using the authentication image, and
wherein the image sharing service server is configured to transmit the authentication image to the user terminal.

28. The mobile communication system of claim 27, wherein the user terminal is configured to capture an image by issuing requests to a camera, and determine whether a similarity between the captured image and the received authentication image is greater than a threshold.

29. The mobile communication system of claim 28, wherein the user terminal is configured to display the image captured by the camera together with the generated coupon, and wherein the generated coupon comprises a virtual three-Dimensional (3D) coupon.

30. The mobile communication system of claim 29, wherein the user terminal is configured to store the coupon into a memory upon detection of a selection of the displayed coupon.
